(19) United States
(12) Patent Application Publication
(10) Pub. No.: US 2025/0138720 A1
(43) Pub. Date: May 1, 2025

(54) SYSTEM FOR CONTROLLING AT LEAST ONE OF A SET OF FUNCTIONS IN A VEHICLE INTERIOR, ASSOCIATED METHOD AND COMPUTER PROGRAM

(71) Applicant: FAURECIA SERVICES GROUPE, Nanterre (FR)

(72) Inventor: Cyril LAURY, Antony (FR)

(21) Appl. No.: 18/927,752

(22) Filed: Oct. 25, 2024

(30) Foreign Application Priority Data
Oct. 25, 2023 (FR) FR 2311582

(51) Int. Cl. G06F 3/04847; B60K 35/22; B60K 35/28; B60K 35/53; G06F 3/01; G06F 3/0482; G06F 3/0487; G06F 3/16

(52) U.S. Cl. CPC G06F 3/04847; B60K 35/22; B60K 35/285; B60K 35/53; G06F 3/0482; G06F 3/0487; B60K 2360/126; B60K 2360/148; B60K 2360/741; G06F 3/013; G06F 3/167

(57) ABSTRACT

A control system having a display screen, at least one image sensor, and a physical element mechanically linked to the display screen and movable by a user between at least two distinct positions. The physical element is not electrically connected to the display screen. The image sensor is configured to capture images of the physical element and of at least part of the display screen. The system includes an electronic control unit configured for assigning a function to the physical element; detect in at least one image captured by the sensor, a position of the physical element following a manipulation by the user; determine an action associated with the function, the action being variable depending on the position of the physical element; and control the implementation of the action corresponding to the position of the physical element.

This application claims priority to French Patent Application No. 2311582 filed Oct. 25, 2023, the entire disclosure of which is incorporated by reference herein.

### TECHNICAL FIELD

The present invention relates to a system for controlling at least one of a set of functions in a vehicle interior.

The invention also relates to a method for controlling at least one function from a set of functions in an associated vehicle interior, and to an associated computer program.

The invention is in the field of man-machine interfaces for vehicles, and in particular for motor vehicles.

### BACKGROUND

Various vehicles, and in particular motor vehicles, include on-board computing systems, which are configured to control numerous on-board devices, and to control actions associated with various functions.

To control actions associated with various functions, in particular comfort functions, for example adjusting the temperature in the vehicle cabin, the lighting, the amount of ventilation, etc., it is common to have dedicated man-machine interfaces. A large number of interfaces to be installed in the passenger compartment, typically at the front of the vehicle at dashboard level, requires a lot of space. Moreover, each interface has to be connected to the equipment and/or to an electronic control unit, which leads to complex connectivity.

To lessen this space requirement, it has been proposed to use controls based on gestures made by the vehicle's users, for example by the driver, the vehicle being equipped with cameras to detect the direction of gaze of the driver and/or passenger. However, this is not a satisfactory solution because to control many interfaces a large number of gestures have to be learned. Furthermore, such commands are unnatural and not appreciated by users. In addition, this type of control adds a mental burden on the driver, which presents safety risks.

### SUMMARY

An object of the present invention is to provide a man-machine interface that is simplified in terms of space requirements and electrical wiring, while being easy to use for a vehicle user, such as the driver.

To this end, the invention relates to a system for controlling at least one of a set of functions in a vehicle interior, comprising a display screen and at least one image sensor. This system comprises a physical element mechanically linked to said display screen and movable by a user between at least two distinct positions, said physical element not being electrically connected to said screen, said at least one image sensor being configured to capture images of said physical element and of at least part of the display screen, the system further comprising an electronic control unit connected to said image sensor, the electronic control unit being configured for:
assigning a function to said physical element,
detecting, in at least one image captured by said sensor, a position of said physical element following a manipulation by the user,
determining an action associated with said function, the action being variable depending on the position of the physical element, and
controlling the implementation of the action corresponding to the position of the physical element.

Advantageously, the use of a physical element that is simply mechanically linked to the display screen and not electrically connected minimizes the number of interface elements and electrical connections required, while being simple and intuitive to use for a user of the vehicle.

According to other advantageous aspects of the invention, the control system comprises one or more of the following features, taken alone or in any technically feasible combination.
The physical element is a knob, the position of which is changed by rotating the knob.
The physical element is a cursor, a change in the position of said cursor being effected by a translation of said cursor.
The system is configured to display, on said display screen, a menu relating to the function assigned to said physical element, the menu comprising sections arranged so that the selected position of the physical element indicates one of said sections.
The system is configured to display, on said display screen, a main menu of functions of said set of functions.
The system further includes a module for tracking the direction of gaze of one of the vehicle's users, and a function is assigned to said physical element as a function of the detected direction of gaze, with the main menu function to which the gaze direction is directed being assigned to said physical element.
Assigning function to said physical element is achieved by implementing manipulation of the physical element to indicate function displayed in the main menu, and detecting, in an image captured by said sensor, the position of said physical element.
The system further comprises a voice recognition module, and the assignment of a function to said physical element is carried out by voice command.

The invention also relates to a method of controlling at least one function from a set of functions in a vehicle interior, implemented by a system as briefly described above. The system comprises steps of:
assigning function to said physical element,
detecting, in at least one image captured by said sensor, a position of said physical element following manipulation by the user,
determining an action associated with said function, the action being variable depending on the position of the physical element, and
controlling the implementation of the action corresponding to the position of the physical element.

The invention also relates to a non-transitory, computer-readable medium having stored thereon a computer program comprising software instructions which, when executed by a computer, implement a method of controlling at least one function from a set of functions in a vehicle interior as defined above.

### BRIEF DESCRIPTION OF THE DRAWINGS

The invention will become clearer on reading the following description, given solely by way of non-limiting example, and made with reference to the drawings, wherein:

FIG. 1 is a schematic view of part of a vehicle interior wherein a control system is installed;

FIG. 2 is an overview of a control system according to one embodiment,

FIG. 3 is a block diagram of the main steps of a method of control according to one embodiment.

### DETAILED DESCRIPTION

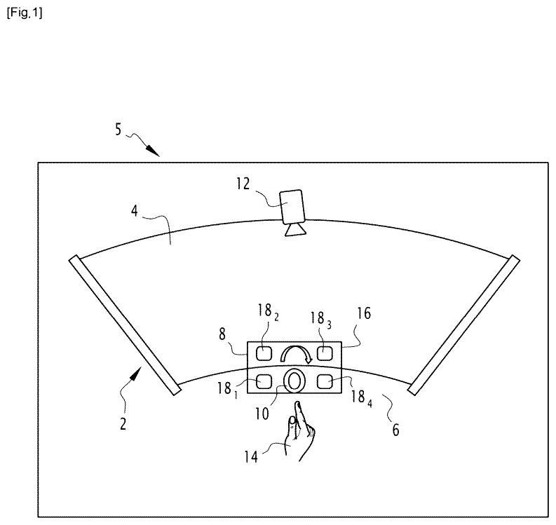

FIG. 1 schematically illustrates a passenger compartment 2 of a motor vehicle 5.

The invention is more generally applicable to any other type of vehicle.

The passenger compartment 2 is a front part of the vehicle, comprising a windshield 4 and a dashboard 6.

A display screen 8, for example, is inserted into the instrument panel 6.

Advantageously, a physical element 10, represented by a knob that can be rotated between at least two distinct positions, is mechanically attached to the display screen 8.

Advantageously, the physical element 10 is not electrically connected to the display screen 8.

In addition, the vehicle interior 2 comprises an image sensor 12, in the example shown a camera 12, which is positioned so as to capture, within its viewing angle, images of said display screen and said physical element.

The physical element 10 can be manipulated by a user, in particular by an action of the user's hand 14. The user is typically a user of vehicle 5, for example the driver or front passenger.

In the example shown, rotary knob 10 can be turned in a first direction (e.g., to the left) and in a second direction (e.g., to the right) by the user.

On display screen 8, a menu 16 is shown, comprising several sections 18₁, 18₂, 18₃, 18₄.

In one embodiment, a function is pre-assigned to the physical element 10, and each section 18; of the displayed menu 16 is associated with an action related to the assigned function.

Manipulating the physical element 10, that is, rotating the knob to indicate one of the sections, allows the user to position the knob to indicate it by the position of the knob 10.

Preferably, the knob is provided with a mark, for example a colored mark, the mark pointing in a direction chosen by the user.

The function associated with the knob is, for example, the control of ventilation fan speed or the adjustment of cabin temperature.

Advantageously, it is proposed to detect in images captured by the image sensor 12, a modification of the position of the physical element 10 by a user, and to determine an action associated with the function assigned to the physical element, the action being variable depending on the position of the physical element 10.

Alternatively or additionally, menu 16 is a main menu, and each section 18; displayed is representative of a function, with all sections 18 corresponding to a set of functions. Manipulating the physical element 10 by the user then enables one of the functions to be selected, and therefore one of the set of functions offered to the physical element 10 to be assigned.

In the example shown, the sections 18; of the menu 16 are shown as small icons. Alternatively, any form of menu section can be used, as long as manipulation of the physical element 10 indicates a section chosen by the user. For example, for a rotary knob, the sections, of any shape, are positioned so as to be angularly distributed around the rotary knob.

In one variant, the physical element is a slider that can be moved in translation, and the menu sections are distributed linearly along the path provided for the slider.

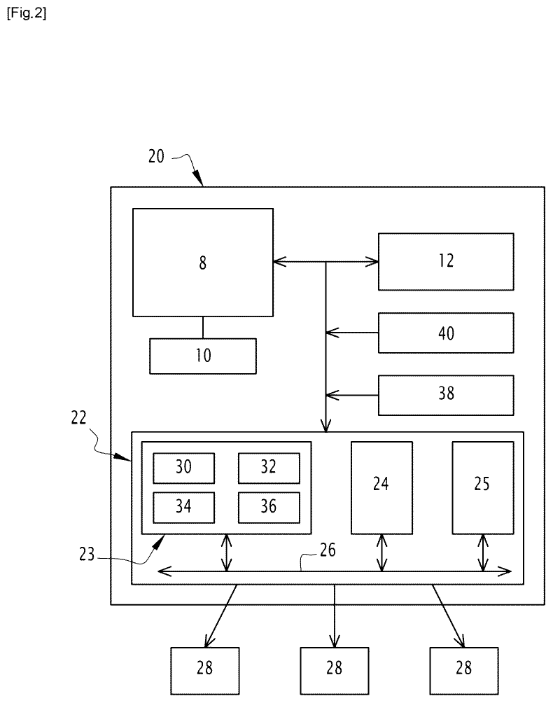

FIG. 2 schematically shows a system 20 for controlling at least one of a range of functions in a vehicle interior.

The system 20 comprises a display screen 8, a physical element 10 mechanically linked to the display screen and manipulable by the user in at least one degree of freedom, and at least one image sensor 12.

The physical element 10 is advantageously movable between at least two distinct positions, preferably gradually and almost continuously movable between two stop positions.

The system 20 further comprises an electronic control unit (ECU) 22, which is connected to the image sensor(s) 12, to the display screen 8, via a communication bus.

The electronic control unit 22 forms a programmable electronic device comprising a computing processor 23, an electronic memory unit 24 and communication interface units 25, linked by an internal communication bus 26.

The electronic control unit 22 is configured to control actions for the implementation of various functions by on-board devices 28. The on-board equipment 28 is diverse, for example a cabin thermal control module, seat control module, infotainment system, etc.

In addition, the electronic control unit 22 is configured to communicate with the image sensor 12.

The electronic control unit 22 is further configured to control the display on the display screen 8.

The computing processor 23 of the electronic control unit 22 is configured to execute a module 30 for assigning a function to the physical element 10, a module 32 for detecting the position of the physical element 10 in an image captured by the image sensor 12 following manipulation of the physical element by the user, a module 34 for determining an action associated with the position of the physical element 10 and a module 36 for controlling the implementation of the action corresponding to the position of the physical element.

Optionally, the system 20 further comprises a voice recognition module 38, which is either independent and connected to the electronic control unit 22, or integrated into the electronic control unit 22.

The voice recognition module 38 is configured to recognize a voice command to assign function to the physical element. The voice command is formulated, for example, by the driver or another user of the vehicle.

Optionally, the system also includes a module 40 for detecting the direction of gaze of one of the vehicle's users, such as the driver, the module 40 being either independent and connected to the electronic control unit 22, or integrated into the image sensor 12. The module 40 for detecting the direction of gaze integrates for example an image sensor judiciously positioned in the passenger compartment of the vehicle and a computing processor making it possible to detect the driver's direction of gaze, for example by a 3D vector in a given spatial frame of reference. Such modules for detecting the direction of the driver's gaze are known, for example, in the field of driver monitoring systems or DMS.

The module 40 is configured to detect the direction of gaze, for example of the vehicle driver, and to transmit this direction to the electronic control unit 22, which is configured to assign a function to the physical element 10 as a function of the detected direction of gaze.

Each of the voice recognition 38 and gaze direction detection 40 modules is connected to the control electronics unit 22.

Advantageously, the physical element 10 is not electrically connected to the display screen.

More generally, in embodiments, the physical element 10 has no electrical connection cable, so it is not electrically connected to any other element of the system 20.

In one embodiment, the modules 30, 32, 34, 36 and optionally 38, 40 are made in the form of software instructions forming a computer program, which, when executed by a computer, implements a control method according to the invention.

The computer program comprising software instructions is furthermore able to be recorded on a non-transitory computer-readable medium. The computer-readable medium is for example a medium able to store the electronic instructions and to be coupled to a bus of a computer system. As an example, the readable medium is an optical disc, a magneto-optical disc, a ROM memory, a RAM memory, any type of non-volatile memory (for example EPROM, EEPROM, FLASH, NVRAM), a magnetic card or an optical card.

In a variant not shown, the modules 30, 32, 34, 36 and optionally 38, 40 are each made in the form of programmable logic components, such as FPGAs (Field-Programmable Gate Arrays), microprocessors, GPGPU components (General-Purpose Graphics Processing Unit), or dedicated integrated circuits, such as ASICs (Application-Specific Integrated Circuits).

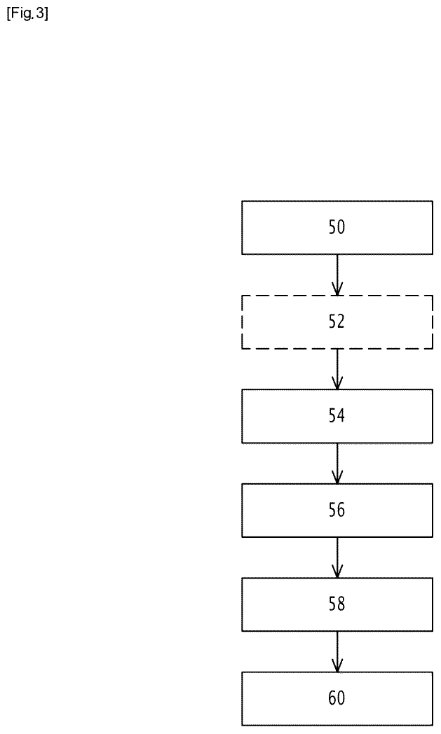

FIG. 3 is a flowchart of the main steps of a method of controlling at least one function from a set of functions according to one embodiment.

The method is implemented by a control system 20 as described above.

The method comprises a step 50 for assigning one of a plurality of functions to a physical element 10.

Preferably, a function is assigned by interaction with the user.

There are several ways of carrying out this step

For example, step 50 is implemented by voice recognition, with the function selected by the user and spoken aloud. A voice recognition module 38 is then implemented.

According to a variant, in step 50, a so-called main menu, comprising a plurality of proposed functions, is displayed (step 52) on the display screen.

A function is assigned, for example, following detection of the direction of gaze of a selected user, such as the driver, the assigned function being the one towards which the detected gaze direction is oriented among the displayed functions.

According to another variant, the display screen is a touch screen, and the user selects by pressing on the screen, using a finger for example, on a section of the display screen containing the display of a function.

According to another variant, following display of the main menu, the main menu comprising several sections, each section containing the display of a function, the user's selection is made by manipulating the physical element to indicate by the position of the physical element the function selected.

Two or more of the above variants can be combined, which makes it possible to improve ergonomics for users and making the assignment of function to the physical element more robust.

After assigning function to the physical element, the method includes an optional step of displaying a menu relating to the assigned function, the menu comprising sections, each section being associated with an action related to the function assigned to the physical element.

Displaying a function-related menu is optional, as for some functions it is not necessary. For example, for the “temperature control” function, a convention of moving the physical element can be applied: for example, in the case of a rotary knob, rotation in a first direction, to the left for example, indicates a decrease in temperature, and rotation in a second direction, to the right, indicates an increase in temperature. Similarly, when the physical element is a slider, moving the slider in a first direction, for example to the left, indicates a decrease in temperature, and moving it in a second direction, to the right, indicates an increase in temperature. This type of operation also applies, for example, when the function is to adjust the amount of ventilation or the level of lighting in the passenger compartment.

For other functions, it is useful to display several sections, for example icons containing text or illustrations, to indicate categories of actions associated with the function.

The method comprises a step 54 of acquiring at least one image, obtained by the image sensor, showing the physical element and all or part of the display screen, followed by a step 56 of analyzing the captured image(s) to determine a position of the physical element following manipulation by the.

The position of the physical element is relative to a predetermined axis, for example a vertical axis for a rotary knob, or a horizontal axis for a cursor.

The method then includes a step 58 for determining an action, associated with the function assigned to the physical element, based on the position of the physical element.

For example, when a function menu is displayed, the position relative to the predetermined axis indicates (that is, points to) one of the sections displayed, and the action associated with the indicated section is the action determined in step 58.

More generally, the action to be controlled is variable depending on the position of the physical element.

The method further comprises a step 60 for controlling the implementation of the action determined in step 58.

The invention has been described in an embodiment wherein a physical element 10 is placed on the dashboard and is mechanically linked to the dashboard.

According to variants, several such physical elements (e.g., knobs and/or sliders) are installed, so as to easily enable the control of several functions at the same time.

Advantageously, the electrical wiring required is greatly reduced, and the number of man-machine interface elements is also reduced.

Advantageously, the connection between the physical element and the screen is simply mechanical, making servicing and maintenance easier.

Advantageously, any upgrading or updating of functions is carried out mainly by software programming, with no need to modify wiring, making it easier to update on-board functions.

1. A system for controlling at least one of a set of functions in a vehicle interior, comprising a display screen and at least one image sensor, comprising a physical element mechanically linked to said display screen and movable by a user between at least two distinct positions, said physical element not being electrically connected to said display screen, said at least one image sensor being configured to capture images of said physical element and of at least part of the display screen, the system further comprising an electronic control unit connected to said image sensor, the electronic control unit being configured to:
assign a function to said physical element,
detect in at least one image captured by said sensor, a position of said physical element following manipulation by the user,
determine an action associated with said function, the action being variable depending on the position of the physical element, and
control the implementation of the action corresponding to the position of the physical element.

2. The system according to claim 1, wherein said physical element is a knob, a change in the position of said knob being affected by rotation of the knob.

3. The system according to claim 1, wherein said physical element is a slider, a modification of the position of said slider being affected by a translation of said slider.

4. The system according to claim 1, configured to display, on said display screen, a menu relating to the function assigned to said physical element, the menu comprising sections arranged in such a way that the selected position of the physical element indicates one of said sections.

5. The system according to claim 1, configured to display, on said display screen, a main menu of functions of said set of functions.

6. The system according to claim 5, further comprising a module for detecting a direction of gaze of one of the vehicle users, and wherein the assignment of a function to said physical element is performed according to the detected direction of gaze, the main menu function towards which the gaze direction is oriented being assigned to said physical element.

7. The system according to claim 5, wherein the assignment of a function to said physical element is effected by implementing a manipulation of the physical element to indicate a function displayed in the main menu, and detecting, in an image captured by said sensor, the position of said physical element.

8. The system according to claim 1, further comprising a voice recognition module, wherein the assignment of a function to said physical element is performed by voice command.

9. A method of controlling at least one function from a set of functions in a vehicle interior, implemented by the system according to claim 1, comprising the steps of:
assigning a function to said physical element,
detecting, in at least one image captured by said sensor, a position of said physical element following manipulation by the user,
determining an action associated with said function, the action being variable depending on the position of the physical element, and
controlling the action to be performed corresponding to the position of the physical element.

10. A non-transitory, computer-readable medium having stored thereon a computer program comprising executable code instructions which, when executed by a programmable electronic device, implement the control method according to claim 9.
